(19) United States
(12) Patent Application Publication
(10) Pub. No.: US 2007/0153804 A1
(43) Pub. Date: Jul. 5, 2007

(54) Methods and systems for maintaining the address of Internet Protocol compatible devices

(76) Inventors: Andrew Roy McGee, Toms River, NJ (US); Steven H. Richman, Highland Park, NJ (US); S. Rao Vasireddy, Holmdel, NJ (US)

Correspondence Address: HARNESS, DICKEY & PIERCE, P.L.C., P.O. BOX 8910, RESTON, VA, 20195, US

(21) Appl. No.: 11/320,649

(22) Filed: Dec. 30, 2005

(51) Int. Cl. H04L 12/56

(52) U.S. Cl. 370/395.52

(57) ABSTRACT

Disconnect and re-connect communication signals are used to initiate a process to determine the physical, logical and/or both addresses of an Internet Protocol compatible device may have changed when the device moves from one physical location to another.

### BACKGROUND OF THE INVENTION

The 911 emergency telephone system is well known to many people. In an emergency, a person can depress the numbers 9-1-1 on her telephone and have the police or ambulance (hereafter referred to as “first responders”) respond quickly. Perhaps less well known is the fact that when the 911 system is called the system automatically matches the calling party's telephone number with a physical address stored in its database. This address may be supplied to first responders.

The ability to provide an accurate physical address of a calling party becomes difficult when those in need of emergency first aid choose to contact a 911 system using an Internet Protocol (IP) compatible, portable device. For example, personal digital assistants (PDAs), IP compatible telephones and portable laptops (collectively “IP compatible” devices) are all capable of initiating contact with a 911 system even though their user may move them from one location to another. By portable device is meant a device that is capable of being moved from one location to another. Sometimes such a device will be a wireless device, other times it may be a wired device that may be unplugged and re-plugged into a different telecommunication outlet or jack, for example.

Though a device may have a dedicated logical address (e.g., IP address) or physical address (e.g., geographical street address) assigned to its initial physical location, when a user of the device moves from one location to another there is presently no way for a 911 system to determine the device's new physical address absent a complicated process of first contacting the administrator of the 911 system. As will be apparent to the reader, someone in need of emergency services does not have the time or wherewithall to go through such an administrative process. Absent the ability to determine the new physical address, any pre-existing address stored in the 911 system may be inaccurate.

Further complicating matters is the fact that next generation network (NGN), IP networks will allow users to access a network almost anywhere there is a network interface. In such a case, not only has the physical address of the user changed but the device may have a new IP address as well. In addition, with the introduction of Voice-over-Internet-Protocol (VoIP) telephony, users will be able to move the same VoIP telephone from place to place causing similar problems.

### SUMMARY OF THE INVENTION

The difficulties described above are overcome in accordance with the principles of the present invention by making use of disconnect and re-connect signals that are generated each time a portable device disconnects from, or reconnects to, a network.

In particular, the present invention detects a disconnect event signal associated with the disconnection of an IP compatible device from a network and, in response to the receipt of such a signal, then generates and forwards a standby signal to an address storage device that is responsible for maintaining the last known physical and/or logical address of the IP compatible device. The standby signal is used as a trigger to inform the storage device that a change in the IP address or physical address associated with the IP compatible device stored in the address storage device may be imminent. The address storage device may comprise one or more databases and database controllers.

When the device subsequently reconnects to the network a reconnect event signal is detected. The new IP address or physical location (referred to as “next address”) of the device associated with its re-connected location may thereafter be retrieved. Subsequently the address storage device may compare the next address to an existing address to determine whether or not a change has occurred. If a change has occurred, the storage device may replace the existing address with the next address in order to insure that the address storage device and/or a related emergency services network are timely provided with the most recent addresses associated with the IP compatible device.

### BRIEF DESCRIPTION OF THE DRAWINGS

FIG. 1 depicts a network that includes an emergency services capability, where the network is capable of determining the physical address of IP compatible devices as they move from one location to another according to embodiments of the present invention.

### A MORE DETAILED EXPLANATION OF THE INVENTION, USING EXAMPLES

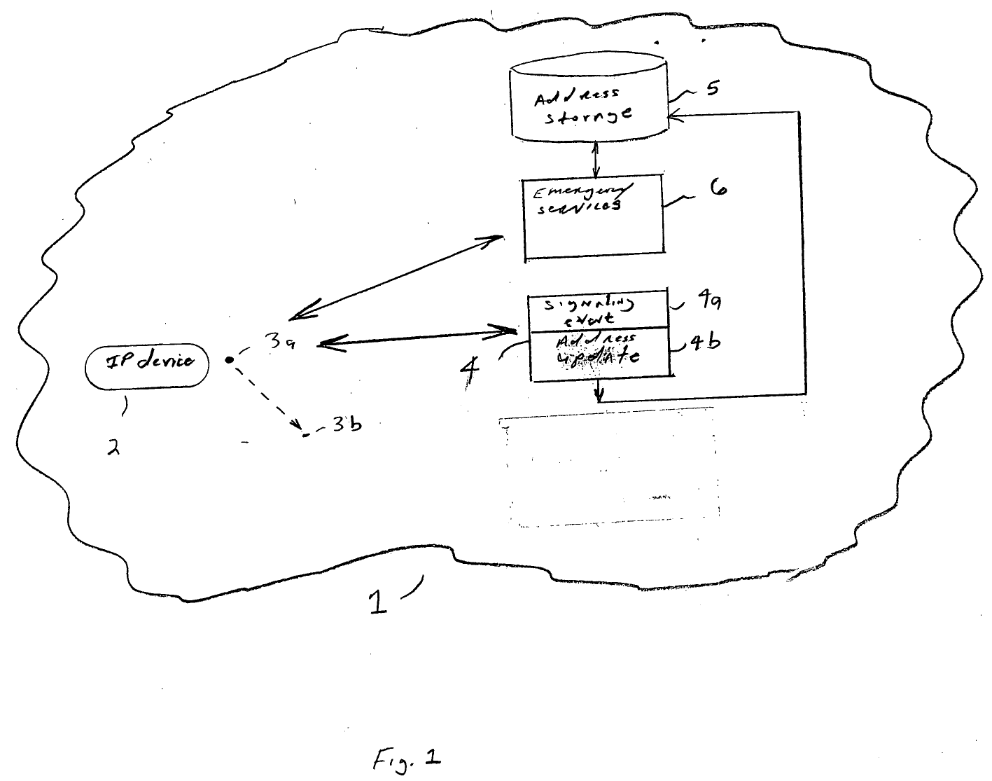

Referring to FIG. 1, there is shown a network 1 that contains an IP compatible device 2. The network 1 may, for example, be a dedicated VoIP network or one that is capable of transporting VoIP and non-VoIP signals. As shown, the IP compatible device 2 is connected at location 3a via a network element (not shown) to the network 1. As is known by those skilled in the art, the network 1 has the ability to receive the location of the device 2 by any number of means, such as by information relayed from a Global Positioning Satellite, from proprietary systems (e.g., Lucent Technologies, Inc.'s iLocator system), or via voice or textual inputs from a user of device 2. At some point in time the device 2 may move from location 3a to 3b as indicated by the dotted lines in FIG. 1. The challenge facing network 1 is to accurately determine when the device 2 has moved in order to further obtain the physical and/or logical address (collectively referred to as “address” hereafter) of the device 2 after it moves so that, for example, when the user of device 2 requests emergency assistance the first responders to such a request are able to locate the user. Given the fact that the first responders most likely will be provided this address directly or indirectly by the network 1, it becomes important for the network 1 to somehow determine when the device 2 has moved along with where it has moved to.

As is also known by those skilled in the art, when the device becomes disconnected from the network 1 at location 3a a disconnect or disconnect event signal is typically generated by a network element that is capable of operating using a protocol which runs between the element located at location 3a and device 2 or by the device 2 itself. This disconnect event signal may be forwarded to the network 1. Today, however, this disconnect event signal is not used to further determine the present or subsequent address of device 2.

It was the ingenuity of the present inventors to recognize that disconnect (and re-connect) event signals could be used to initiate a process to determine when the address of an IP compatible device is about to change as it moves from one location to another.

In one embodiment of the invention, a signaling event section 4a of an update application device, section or unit (collectively referred to as “device”) 4 is operable to detect the disconnect event signal when it is forwarded as the device 2 disconnects from location 3a presumably to move to point 3b. The device 4 may, for example, comprise a server that updates information associated with the device 2 (and its user). One example of such a device is a Home Subscriber Server. Alternatively, the update application device 4 may be part of, or coupled to, a statistical multiplexer or the like.

Though the present discussion assumes that points 3a and 3b are two different physical/logical locations, they need not be. That is, if the device 2 and its user disconnects from location 3a at one point in time and then reconnects to the same physical location at a later time this later location is still referred to as location 3b. Even though the device 2 is being reconnected to the same location, the process for obtaining the new address of the device 2 remains the same. For this reason, however, we will refer to the subsequent location 3b of the device 2 as a “next” location in order to recognize that location 3b may be either a new physical/logical location or the same physical/logical location that the user has chosen to reconnect to for some reason or other. Similarly, this next location has associated with it a “next” address of the device 2.

After the signaling event section 4a detects a disconnect event signal it may be further operable to communicate with an address update section 4b. Sections 4a and 4b communicate with one another in order to initiate a process for determining the next address of the device 2. For example, section 4a may send a signal or instruction to section 4b notifying it that it has received a disconnect event signal after which section 4b is operable to begin an updating process. This process aims to obtain a next address of the device 2 when it moves, changes or reconnects to location 3b. In one embodiment of the present invention, in response to the detection of the disconnect event signal the address update section 4b is operable to generate and forward a standby signal to an address storage device 5 (e.g., one or more databases and database controllers) shortly after the signaling event section 4a receives the disconnect event signal.

In a further embodiment of the present invention, the standby signal acts as a trigger to inform storage device 5 that a change to an existing physical or IP (or both) address, associated with the location of device 2, and stored within device 5, may be imminent. Of course it may also be on indication that the device 2 has reconnected to the same physical or logical location.

It should be noted that the examples just given are just that; there are many more scenarios where a disconnect or reconnect signal may be generated, including the accidental disconnection/reconnection of the device 2. All of these examples may be detected and acted upon in accordance with the present invention.

Continuing, upon receiving a standby signal the address storage device 5 may be operable to locate the stored physical address and/or logical address associated with the device 2 and “flag/tag” its entry to indicate that a change to its stored address may be imminent. Thus, if an entry is flagged, etc . . . and subsequently the emergency services network 6 requests the address associated with device 2, the network 6 will receive the address and the flag. This provides a warning, of sorts, to the network 6 that the existing, stored address associated with the device may now not be reliable enough to forward on to a first responder.

Upon arriving at location 3b, the device 2 reconnects to a network element (not shown). As is known by those skilled in the art, a reconnection or reconnect event is generated. Much like the disconnect event signal, this signal can also be sent to the network 1 using many different means (e.g., GPS, a network element or the like (not shown) located at location 3b, or by the device 2.). Up until now, however, this signal has not been used to determine when it is time to update an existing address of a device, such as device 2, as it moves from place to place.

In accordance with yet a further embodiment of the invention, this re-connect signal may be sent to the network 1 and detected by section 4a. Because this reconnect event signal may represent a new or the same address for the device 2 we will refer to this re-connect signal as a “next” connection event signal.

Typically, a next address associated with location 3b is forwarded on to the network 1 sometime after the next connection event signal is forwarded. Sometimes the network 1 prompts the device 2 before the next address is sent. Other times a network element located at location 3b may prompt the user in order to obtain the next address. Yet other times the IP compatible device 2 may initiate the forwarding of the next address without being prompted by the local network element located at 3b or the network 1. In any case, the next address associated with the location 3b may be forwarded on, and received by, the network 1.

More specifically, in one embodiment of the invention, the network 1 is provided with the ability to know when it is time to potentially update an existing address stored within storage device 5 when the applications device 4 detects the next connection signal and obtains the next address (physical, logical or both) of the IP compatible device 2 associated with the next location 3b of the device.

In a further embodiment of the invention, section 4b may be further operable to receive the next address and forward it on to the address storage device 5. In this manner, the address storage device 5 receives the next address associated with device 2 and removes any previously marked flag or tag. The device 5 may be operable to compare the received next address to an existing address associated with the IP-compatible device 2 and, if applicable, replace the existing address with the next address. If, thereafter, the user of device 2 needs emergency assistance its next address will be available for use by the emergency services network 6.

It should be understood that the emergency services network 6 may initiate, or may be automatically forwarded, the next address of IP compatible devices, such as device 2. Said another way, the emergency services network 6 may be operable to communicate with the address storage device 5 in order to obtain a next address of the IP compatible device 2. Thereafter, the emergency services section or network 6 (collectively referred to as “network”) may use this next address to locate the user of device 2 during an emergency.

In one embodiment of the invention, the emergency services network 6 may comprise a 911 emergency services network and/or a back-up 911emergency services network (collectively, both are hereafter referred to as “911 emergency services network”).

Backtracking somewhat, the address update section 4b may be operable to obtain the next address of the device 2 with or without first initiating a request for such an address. That is to say, that the device 2 may first initiate the process of forwarding the next address, or section 4b, section 4a, a local network element (e.g., one located at position 3b) or remote element may initiate a request for such information.

In yet additional embodiments, the present invention provides features for determining whether or not the user of the device 2 is an authorized user, e.g., that the device 2 has not been stolen. Though typically this authentication process may occur before any next address is requested by elements of network 1, it should be understood that it may occur at any point desirable or advantageous to the operator of network 1, for example.

In one embodiment of invention, the address update section 4b may be further operable to forward an authorization request to the IP compatible device 2 prior to requesting or obtaining the next address from the device 2.

After forwarding the authorization request the address update section 4b may be further operable to wait for a response from the IP compatible device 2. Assuming such a response is sent by the IP compatible device 2, section 4b may be operable to receive such a response and to initiate an authentication process. For example, section 4b (or another part of the network 1) may compare information within a response sent by the IP compatible device 2 to stored information (e.g., password and identification information) in order to determine if the user of device 2 is in fact an authenticated or authorized user. A user may be authenticated in any number of ways. Suffice it to say that it is not necessary for an understanding of the present invention to discuss each conceivable authentication process. All that is required is that some practical and compatible method of authenticating a user be used by the network 1.

Assuming the user is authenticated, the address update section 4b may be further operable to then forward a request in order to obtain the next address of the IP compatible device 2. Assuming the request is received by the device 2, and the device 2 responds by forwarding its next address onto the network 1, the address update section 4b may be operable to receive this next address. This next address may provide a next physical or logical address (or both) for the device 2.

It should be understood that although sections 4a and 4b are shown as two sections, they may be combined into one section or separated into more than two sections. Similarly, the storage device 5 and the emergency services network 6 may be combined into one or further separated into many separate devices/networks.

It should also be understood that sections 4a and 4b may typically be embodied in one or more firmware or software programs. As such the programs may be stored within device 4. The device 4 may comprise one or more types of programmed mediums, or computer readable mediums, such as a hard disc, on-board memory, or CD or a combination of one or more of such memory devices and one or more processors for storing the programs and executing code making up the programs in order to carry out the features and functions of the present invention. Alternatively, application device 4 (and/or sections 4a and 4b) may be operable to receive programs or code via a downloadable process to enable device 4 to carry out the features and functions of the present invention.

Finally, it should be understood that the discussion above only provides some examples of the present invention. Because of this, the scope of the present invention is more accurately set forth in the claims that follow.

We claim:

1. A method for maintaining the address of an Internet Protocol (IP) compatible device comprising:
detecting a disconnect event signal associated with a disconnection of the IP compatible device from a network; and
forwarding a standby signal in response to the receipt of the disconnect event signal,
wherein the standby signal is used to inform an address storage device that a change to an existing address associated with the IP compatible device stored in the storage device may be imminent.

2. The method as in claim 1 wherein the address is a physical address.

3. The method as in claim 1 wherein the address is an IP address.

4. The method as in claim 1 further comprising:
detecting a next connection event signal associated with a re-connection of the IP compatible device to the network at a next location; and
obtaining a next address of the IP compatible device associated with the next location.

5. The method as in claim 4 further comprising forwarding the next address on to the address storage device to ensure that the storage device maintains a most recent address of the IP compatible device.

6. The method as in claim 5 further comprising obtaining the next address of the IP compatible device to contact a user of the device during an emergency

7. The method as in claim 6 wherein a 911 emergency services network obtains the next address.

8. The method as in claim 4 further comprising obtaining the next address without initiating a request for such an address.

9. The method as in claim 4 further comprising forwarding an authorization request to the IP compatible device prior to obtaining the next address.

10. The method as in claim 9 further comprising:
receiving a response from the IP compatible device in response to the request; and
authenticating the IP compatible device based on information in the response.

11. A device for maintaining the address of an Internet Protocol (IP) compatible device operable to:
detect a disconnect event signal associated with a disconnection of the IP compatible device from a network; and
forwarding a standby signal in response to the receipt of the disconnect event signal,
wherein the standby signal is used to inform an address storage device that a change to an existing address associated with the IP compatible device stored in the storage device may be imminent.

12. The method as in claim 1 wherein the address is a physical address.

13. The method as in claim 1 wherein the address is an IP address.

14. The device as in claim 11 further operable to:
detect a next connection event signal associated with a reconnection of the IP compatible device to the network at a next location; and
obtain a next address of the IP compatible device associated with the next location.

15. The device as in claim 12 further operable to forward the next address on to the address storage device to ensure that the storage section maintains a most recent address of the IP compatible device.

16. The device as in claim 12 further operable to obtain the next address without initiating a request for such an address.

17. The device as in claim 12 further operable to forward an authorization request to the IP compatible device prior to obtaining the next address.

18. The device as in claim 17 further operable to:
receive a response from the IP compatible device in response to the request; and
authenticate the IP compatible device based on information in the response.

19. An emergency services network operable to obtain a next address of an IP compatible device after disconnect and next connection event signals associated with the device have been detected,
wherein the next address is used to contact a user of the device during an emergency.

20. The network as in claim 19 wherein the emergency services network comprises a 911 emergency services network.

21. A system for maintaining the address of an Internet Protocol (IP) compatible device comprising an applications device operable to:
detect a disconnect event signal associated with a disconnection of the IP compatible device from a network; and
forwarding a standby signal in response to the receipt of the disconnect event signal,
wherein the standby signal is used to inform an address storage device that a change to an existing address associated with the IP compatible device stored in the storage device may be imminent.

22. The method as in claim 21 wherein the address is a physical address.

23. The method as in claim 21 wherein the address is an IP address.

24. The system as in claim 23 wherein the applications device is further operable to:
detect a next connection event signal associated with a reconnection of the IP compatible device to the network at a next location; and
obtain a next address of the IP compatible device associated with the next location.

25. The system as in claim 24 wherein the applications device is further operable to forward the next address on to the address storage device to ensure that the storage section maintains a most recent address of the IP compatible device.

26. The system as in claim 25 further comprising:
an emergency services network operable to obtain the next address of the IP compatible device,
wherein the next address is used to contact a user of the device during an emergency.

27. The system as in claim 26 wherein the emergency services network comprises a 911 emergency services network.

28. The system as in claim 24 wherein the applications device is further operable to obtain the next address without initiating a request for such an address.

29. The system as in claim 24 wherein the applications device is further operable to forward an authorization request to the IP compatible device prior to obtaining the next address.

30. The system as in claim 29 wherein the applications device is further operable to:
receive a response from the IP compatible device in response to the request; and
authenticate the IP compatible device based on information in the response.
